(19) United States
(12) Patent Application Publication
(10) Pub. No.: US 2024/0413462 A1
(43) Pub. Date: Dec. 12, 2024

(54) BATTERY SYSTEM

(71) Applicant: Rivian IP Holdings, LLC, Irvine, CA (US)

(72) Inventors: Akshay Kishor Murkute, Irvine, CA (US); Kyle Butterfield, Ladera Ranch, CA (US); Samuel Edward Hugley, Long Beach, CA (US)

(21) Appl. No.: 18/332,607

(22) Filed: Jun. 9, 2023

(51) Int. Cl. H01M 50/249; B60L 50/64; H01M 10/625; H01M 10/6554

(52) U.S. Cl. CPC H01M 50/249; B60L 50/64; H01M 10/625; H01M 10/6554; H01M 2220/20

(57) ABSTRACT

A battery system can include a first cell carrier having a first datum. The first datum of the first cell carrier can align with a second datum of a thermal component and at least partially receive a locating feature of a second cell carrier.

Electric vehicles can include various electrical components that provide power to the vehicle. The electrical components can be electrically coupled with vehicle components to power the vehicle.

### SUMMARY

A battery system can facilitate coupling at least two battery cell carriers with a thermal component to form the battery system. The battery system can include a first cell carrier defining a datum (e.g., opening) and a second cell carrier having a locating feature (e.g., a post) that can align with and extend through the datum. The battery system can include a thermal component disposed between the first and second cell carrier. The thermal component can define a datum (e.g., opening) that substantially matches the datum of the first cell carrier such that the datums can align to each at least partially receive the locating feature of the second cell carrier. The second cell carrier (or the first cell carrier) can include at least one protruding rib that extends from a surface of the second cell carrier towards the thermal component and first cell carrier. With this configuration, the first cell carrier, the second cell carrier, and the thermal component can align together (e.g., by aligning the locating feature and the datums together) and can couple with one another by inserting the locating feature through the datums. Responsive to coupling the first cell carrier, the second cell carrier, and the thermal component together, the protruding rib can at least partially deform to absorb a compression load between the first cell carrier, the second cell carrier, and the thermal component.

At least one aspect is directed to a battery system. The battery system can include a first cell carrier having a first datum. The first datum of the first cell carrier can align with a second datum of a thermal component and at least partially receive a locating feature of a second cell carrier.

At least one aspect is directed to an electric vehicle. The electric vehicle can include a battery system. The battery system can include a first cell carrier having a first datum. The first datum of the first cell carrier can align with a second datum of a thermal component and at least partially receive a locating feature of a second cell carrier.

At least one aspect is directed to a method. The method can include providing a first cell carrier having a first datum and a second cell carrier having a locating feature. The method can include aligning the first datum of the first cell carrier with a second datum of a thermal component and at least partially inserting the locating feature of the second cell carrier through the first datum and the second datum to couple the first cell carrier, the second cell carrier, and the thermal component.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example side view of an electric vehicle, in accordance with implementations.

FIG. 2A depicts an example perspective view of a battery pack, in accordance with implementations.

FIG. 2B depicts an example perspective view of a plurality of battery subassemblies of the battery pack of FIG. 2A, in accordance with implementations.

FIG. 2C depicts a cross sectional view of a battery cell, in accordance with implementations.

FIG. 2D depicts a cross sectional view of a battery cell, in accordance with implementations.

FIG. 2E depicts a cross sectional view of a battery cell, in accordance with implementations.

FIG. 2F depicts an example flowchart of a method of forming a battery subassembly, in accordance with implementations.

FIG. 2G depicts an example cross-section of a battery pack, in accordance with implementations.

FIG. 3 depicts an example perspective exploded view of a battery system, in accordance with implementations.

FIG. 4 depicts an example detailed view of a portion of the battery system of FIG. 3, in accordance with implementations.

FIG. 5 depicts another example detailed view of a portion of the battery system of FIG. 3, in accordance with implementations.

FIG. 6 depicts another example detailed view of a portion of the battery system of FIG. 3, in accordance with implementations.

FIG. 7 depicts an example side sectional view of a portion of the battery system of FIG. 3, in accordance with implementations.

FIG. 8 depicts an example perspective view of a portion of the battery system of FIG. 3, in accordance with implementations.

FIG. 9 depicts an example perspective view of a portion of the battery system of FIG. 3 in a first state, in accordance with implementations.

FIG. 10 depicts an example perspective view of a portion of the battery system of FIG. 3 in a second state, in accordance with implementations.

FIG. 11 depicts an example perspective view of a portion of the battery system of FIG. 3 in a first state, in accordance with implementations.

FIG. 12 depicts an example perspective view of a portion of the battery system of FIG. 3 in a second state, in accordance with implementations.

FIG. 13 depicts an example illustration of a process, in accordance with implementations.

FIG. 14 depicts an example illustration of a process, in accordance with implementations.

### DETAILED DESCRIPTION

Following below are more detailed descriptions of various concepts related to, and implementations of, methods, apparatuses, and systems of aligning and coupling a battery system together. For example, the battery system can include a first cell carrier having a datum (e.g., opening) and a second cell carrier having a locating feature (e.g., a post) that can align with and extend through the datum. The battery system can include a thermal component disposed between the first and second cell carrier. The thermal component can define a datum (e.g., opening) that substantially matches the datum of the first cell carrier such that the datums can align to each at least partially receive the locating feature of the second cell carrier. The second cell carrier (or the first cell carrier) can include at least one protruding rib that extends from a surface of the second cell carrier towards the thermal component and first cell carrier. With this configuration, the first cell carrier, the second cell carrier, and the thermal component can align together (e.g., by aligning the locating feature and the datums together) and can couple with one another by inserting the locating feature through the datums. Responsive to coupling the first cell carrier, the second cell carrier, and the thermal component together, the protruding rib can at least partially deform to absorb a compression load between the first cell carrier, the second cell carrier, and the thermal component.

The disclosed solutions have a technical advantage of having internal part-to-part datums. For example, by having a locating feature and datums designed and formed directly on or with the first cell carrier, the second cell carrier, or the thermal component, the battery system reduces or eliminates the need for external datum strategies (e.g., datums external to the first cell carrier, the second cell carrier, or the thermal component) or references to align and couple the battery system together. Further, manufacturing variation is greatly reduced due to interaction of different part and assembly tolerances involved in the coupling process of the battery system. Additionally, since there is no external locating fixture needed, the process cycle time and takt time is greatly improved, thereby improving the manufacturing through-put and yield for high-volume production. Further, part-to-part locating eliminates assembly variation and helps reduced scrap cost.

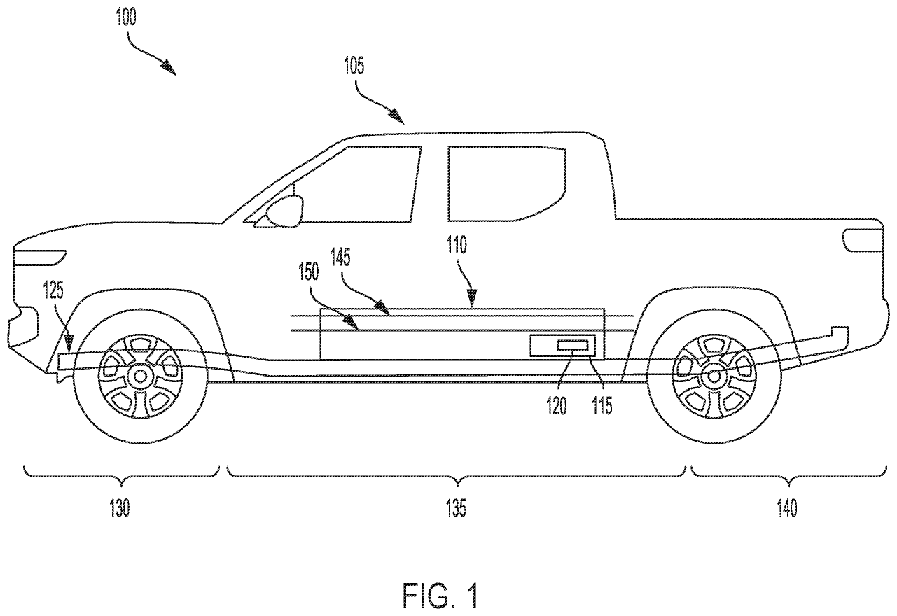

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, batteries 115 or battery subassemblies 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery 115, the battery subassemblies 115, or the battery cells 120 with other electrical components of the electric vehicle 105 to provide electrical power to various systems or components of the electric vehicle 105.

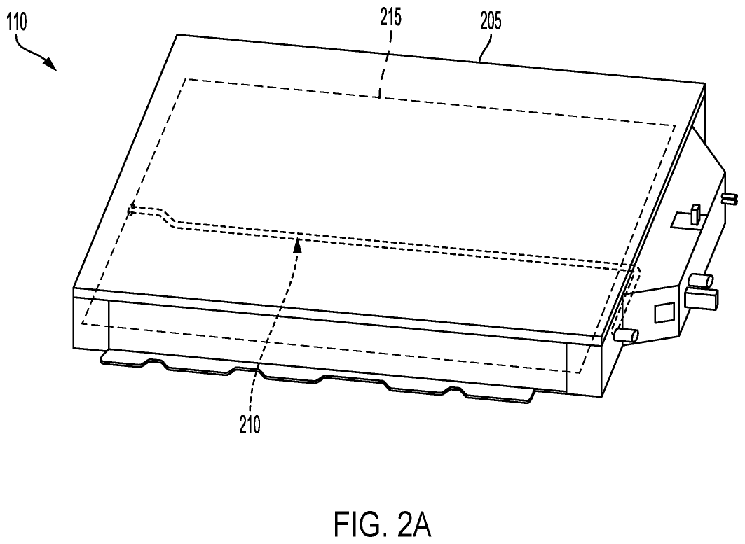

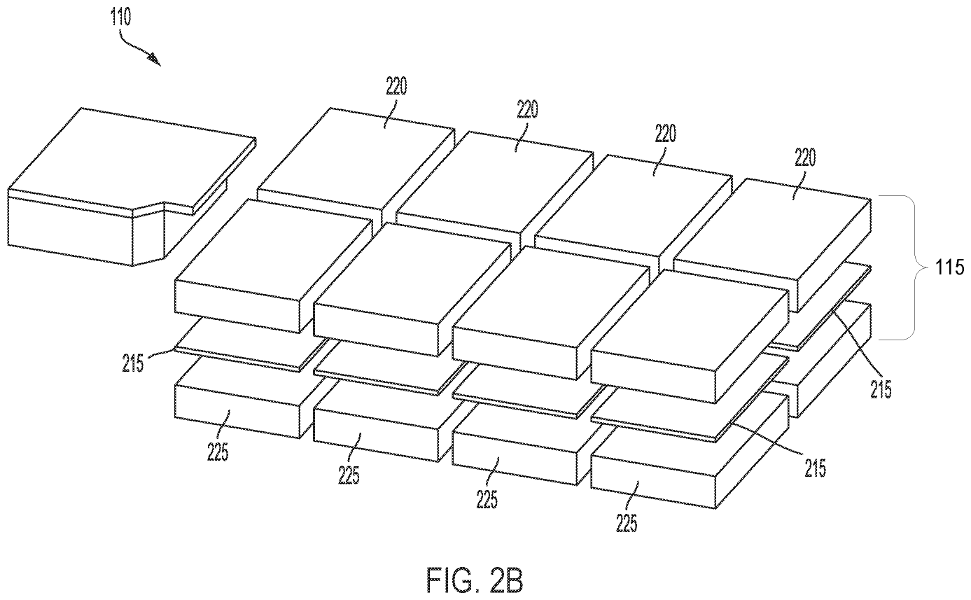

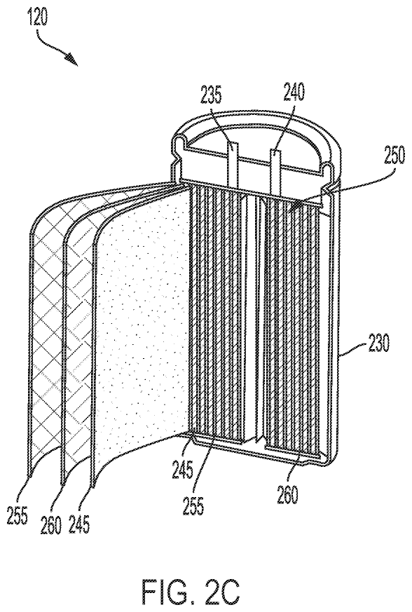

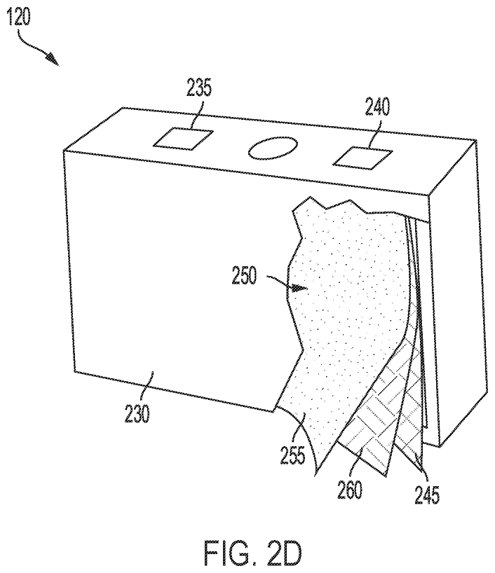

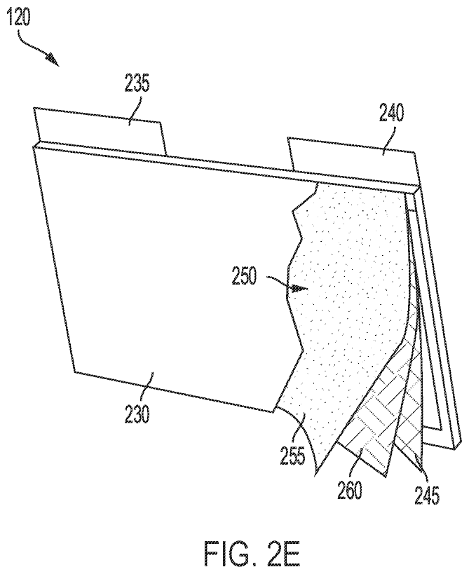

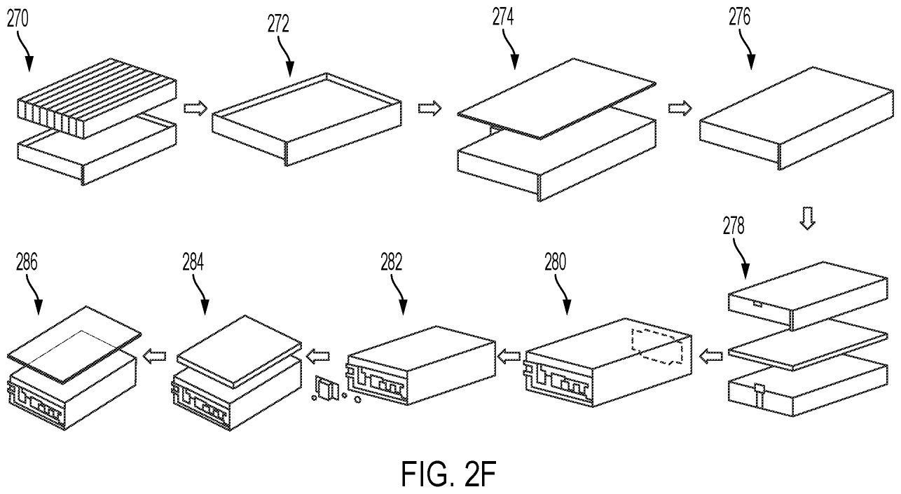

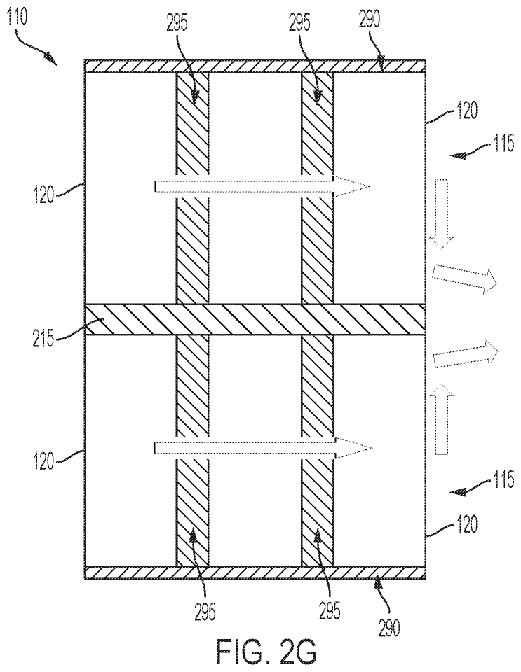

FIG. 2A depicts an example battery pack 110. Referring to FIG. 2A, among others, the battery pack 110 can provide power to electric vehicle 105. Battery packs 110 can include any arrangement or network of electrical, electronic, mechanical or electromechanical devices to power a vehicle of any type, such as the electric vehicle 105. The battery pack 110 can include at least one housing 205. The housing 205 can include at least one battery subassembly 115 or at least one battery cell 120, as well as other battery pack components. The battery subassembly 115 can be or can include one or more groups of prismatic cells, cylindrical cells, pouch cells, or other form factors of battery cells 120. For example, the battery subassembly 115 can be or include one or more battery cell carriers, thermal components 215, modules, or other components that form a joining of a plurality of battery cells 120 together. The housing 205 can include a shield on the bottom or underneath the battery subassembly 115 to protect the battery subassembly 115 and/or cells 120 from external conditions, for example if the electric vehicle 105 is driven over rough terrains (e.g., off-road, trenches, rocks, etc.) The battery pack 110 can include at least one cooling line 210 that can distribute fluid through the battery pack 110 as part of a thermal/temperature control or heat exchange system that can also include at least one thermal component (e.g., cold plate) 215. The thermal component 215 can be positioned in relation to a top submodule and a bottom submodule, such as in between the top and bottom submodules, among other possibilities. The battery pack 110 can include any number of thermal components 215. For example, there can be one or more thermal components 215 per battery pack 110, or per battery subassembly 115. At least one cooling line 210 can be coupled with, part of, or independent from the thermal component 215.

FIG. 2B depicts example battery subassemblies 115, and FIGS. 2C, 2D and 2E depict an example cross sectional view of a battery cell 120. The battery subassemblies 115 can include at least one submodule. For example, the battery subassemblies 115 can include at least one first (e.g., top) submodule 220 or at least one second (e.g., bottom) submodule 225. At least one thermal component 215 can be disposed between the top submodule 220 and the bottom submodule 225. For example, one thermal component 215 can be configured for heat exchange with one battery subassembly 115. The thermal component 215 can be disposed or thermally coupled between the top submodule 220 and the bottom submodule 225. One thermal component 215 can also be thermally coupled with more than one battery subassembly 115 (or more than two submodules 220, 225). The thermal components 215 shown adjacent to each other can be combined into a single thermal component 215 that spans the size of one or more submodules 220 or 225. The thermal component 215 can be positioned underneath submodule 220 and over submodule 225, in between submodules 220 and 225, on one or more sides of submodules 220, 225, among other possibilities. The thermal component 215 can be disposed in sidewalls, cross members, structural beams, among various other components of the battery pack, such as battery pack 110 described above. The battery submodules 220, 225 can collectively form one battery subassembly 115. In some examples each submodule 220, 225 can be considered as a complete battery subassembly 115, rather than a submodule.

The battery subassemblies 115 can each include a plurality of battery cells 120. The battery subassemblies 115 can be disposed within the housing 205 of the battery pack 110. The battery subassemblies 115 can include battery cells 120 that are cylindrical cells or prismatic cells, for example. The battery subassembly 115 can operate as a modular unit of battery cells 120. For example, a battery subassembly 115 can collect current or electrical power from the battery cells 120 that are included in the battery subassembly 115 and can provide the current or electrical power as output from the battery pack 110. The battery pack 110 can include any number of battery subassemblies 115. For example, the battery pack can have one, two, three, four, five, six, seven, eight, nine, ten, eleven, twelve or other number of battery subassemblies 115 disposed in the housing 205. It should also be noted that each battery subassembly 115 may include a top submodule 220 and a bottom submodule 225, possibly with a thermal component 215 in between the top submodule 220 and the bottom submodule 225. The battery pack 110 can include or define a plurality of areas for positioning of the battery subassembly 115 and/or cells 120. The battery subassemblies 115 can be square, rectangular, circular, triangular, symmetrical, or asymmetrical. In some examples, battery subassemblies 115 may be different shapes, such that some battery subassemblies 115 are rectangular but other battery subassemblies 115 are square shaped, among other possibilities. The battery subassembly 115 can include or define a plurality of slots, holders, or containers for a plurality of battery cells 120. It should be noted the illustrations and descriptions herein are provided for example purposes and should not be interpreted as limiting. For example, the battery cells 120 can be inserted in the battery pack 110 without battery modules 220 and 225. The battery cells 120 can be disposed in the battery pack 110 in a cell-to-pack configuration without submodules 220 and 225, among other possibilities.

Battery cells 120 have a variety of form factors, shapes, or sizes. For example, battery cells 120 can have a cylindrical, rectangular, square, cubic, flat, pouch, elongated or prismatic form factor. As depicted in FIG. 2C, for example, the battery cell 120 can be cylindrical. As depicted in FIG. 2D, for example, the battery cell 120 can be prismatic. As depicted in FIG. 2E, for example, the battery cell 120 can include a pouch form factor. Battery cells 120 can be assembled, for example, by inserting a winded or stacked electrode roll (e.g., a jelly roll) including electrolyte material into at least one battery cell housing 230. The electrolyte material, e.g., an ionically conductive fluid or other material, can support electrochemical reactions at the electrodes to generate, store, or provide electric power for the battery cell by allowing for the conduction of ions between a positive electrode and a negative electrode. The battery cell 120 can include an electrolyte layer where the electrolyte layer can be or include solid electrolyte material that can conduct ions. For example, the solid electrolyte layer can conduct ions without receiving a separate liquid electrolyte material. The electrolyte material, e.g., an ionically conductive fluid or other material, can support conduction of ions between electrodes to generate or provide electric power for the battery cell 120. The housing 230 can be of various shapes, including cylindrical or rectangular, for example. Electrical connections can be made between the electrolyte material and components of the battery cell 120. For example, electrical connections to the electrodes with at least some of the electrolyte material can be formed at two points or areas of the battery cell 120, for example to form a first polarity terminal 235 (e.g., a positive or anode terminal) and a second polarity terminal 240 (e.g., a negative or cathode terminal). The polarity terminals can be made from electrically conductive materials to carry electrical current from the battery cell 120 to an electrical load, such as a component or system of the electric vehicle 105.

For example, the battery cell 120 can include at least one lithium-ion battery cell. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 120 to separate the anode and cathode from each other and to facilitate transfer of lithium ions between the anode and cathode. It should be noted that battery cell 120 can also take the form of a solid state battery cell developed using solid electrodes and solid electrolytes. Solid electrodes or electrolytes can be or include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂(XO₄)₃ (A=Ca, Sr, Ba and X=Nb, Ta), lithium phosphorous oxy-nitride (LiₓPO_{y}N₂). In some embodiments, the solid electrolyte layer can include a glassy, ceramic and/or crystalline sulfide-based electrolyte (e.g., Li₃PS₄, Li₇P₃S₁₁, Li₂S—P₂S₅, Li2S—B₂S₃, SnS—P₂S₅, Li₂S—SiS₂, Li₂S—P₂S₅, Li₂S—GeS₂, Li₁₀GeP₂S₁₂) and/or sulfide-based lithium argyrodites with formula Li₆PS₅X (X=Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

The battery cell 120 can be included in battery subassemblies 115 or battery packs 110 to power components of the electric vehicle 105. The battery cell housing 230 can be disposed in the battery subassembly 115, the battery pack 110, or a battery array installed in the electric vehicle 105. The housing 230 can be of any shape, such as cylindrical with a circular (e.g., as depicted in FIG. 2C, among others), elliptical, or ovular base, among others. The shape of the housing 230 can also be prismatic with a polygonal base, as shown in FIG. 2D, among others. As shown in FIG. 2E, among others, the housing 230 can include a pouch form factor. The housing 230 can include other form factors, such as a triangle, a square, a rectangle, a pentagon, and a hexagon, among others. In some embodiments, the battery subassembly may include or be provided as a battery module. In other embodiments, the battery pack may not include modules (e.g., module-free). For example, the battery pack can have a module-free or cell-to-pack configuration where the battery cells are arranged directly into a battery pack without assembly into a module.

The housing 230 of the battery cell 120 can include one or more materials with various electrical conductivity or thermal conductivity, or a combination thereof. The electrically conductive and thermally conductive material for the housing 230 of the battery cell 120 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 230 of the battery cell 120 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others. In examples where the housing 230 of the battery cell 120 is prismatic (e.g., as depicted in FIG. 2D, among others) or cylindrical (e.g., as depicted in FIG. 2C, among others), the housing 230 can include a rigid or semi-rigid material such that the housing 230 is rigid or semi-rigid (e.g., not easily deformed or manipulated into another shape or form factor). In examples where the housing 230 includes a pouch form factor (e.g., as depicted in FIG. 2E, among others), the housing 230 can include a flexible, malleable, or non-rigid material such that the housing 230 can be bent, deformed, manipulated into another form factor or shape.

The battery cell 120 can include at least one anode layer 245, which can be disposed within the cavity 250 defined by the housing 230. The anode layer 245 can include a first redox potential. The anode layer 245 can receive electrical current into the battery cell 120 and output electrons during the operation of the battery cell 120 (e.g., charging or discharging of the battery cell 120). The anode layer 245 can include an active substance. The active substance can include, for example, an activated carbon or a material infused with conductive materials (e.g., artificial or natural graphite, or blended), lithium titanate (Li₄Ti₅O₁₂), or a silicon-based material (e.g., silicon metal, oxide, carbide, pre-lithiated), or other lithium alloy anodes (Li—Mg, Li—Al, Li—Ag alloy etc.) or composite anodes consisting of lithium and carbon, silicon and carbon or other compounds. The active substance can include graphitic carbon (e.g., ordered or disordered carbon with sp² hybridization), Li metal anode, or a silicon-based carbon composite anode, or other lithium alloy anodes (Li—Mg, Li—Al, Li—Ag alloy etc.) or composite anodes consisting of lithium and carbon, silicon and carbon or other compounds. In some examples, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell does not comprise an anode active material in an uncharged state.

The battery cell 120 can include at least one cathode layer 255 (e.g., a composite cathode layer compound cathode layer, a compound cathode, a composite cathode, or a cathode). The cathode layer 255 can include a second redox potential that can be different than the first redox potential of the anode layer 245. The cathode layer 255 can be disposed within the cavity 250. The cathode layer 255 can output electrical current out from the battery cell 120 and can receive electrons during the discharging of the battery cell 120. The cathode layer 255 can also receive lithium ions during the discharging of the battery cell 120. Conversely, the cathode layer 255 can receive electrical current into the battery cell 120 and can output electrons during the charging of the battery cell 120. The cathode layer 255 can release lithium ions during the charging of the battery cell 120.

The battery cell 120 can include a layer 260 disposed within the cavity 250. The layer 260 can include a solid electrolyte layer. The layer 260 can include a separator wetted by a liquid electrolyte. The layer 260 can include a polymeric material. The layer 260 can include a polymer separator. The layer 260 can be arranged between the anode layer 245 and the cathode layer 255 to separate the anode layer 245 and the cathode layer 255. The polymer separator can physically separate the anode and cathode from a cell short circuit. A separator can be wetted with a liquid electrolyte. The liquid electrolyte can be diffused into the anode layer 245. The liquid electrolyte can be diffused into the cathode layer 255. The layer 260 can help transfer ions (e.g., Li⁺ ions) between the anode layer 245 and the cathode layer 255. The layer 260 can transfer Li⁺ cations from the anode layer 245 to the cathode layer 255 during the discharge operation of the battery cell 120. The layer 260 can transfer lithium ions from the cathode layer 255 to the anode layer 245 during the charge operation of the battery cell 120.

The redox potential of layers (e.g., the first redox potential of the anode layer 245 or the second redox potential of the cathode layer 255) can vary based on a chemistry of the respective layer or a chemistry of the battery cell 120. For example, lithium-ion batteries can include an LFP (lithium iron phosphate) chemistry, an LMFP (lithium manganese iron phosphate) chemistry, an NMC (Nickel Manganese Cobalt) chemistry, an NCA (Nickel Cobalt Aluminum) chemistry, an OLO (Over Lithiated Oxide) chemistry, or an LCO (lithium cobalt oxide) chemistry for a cathode layer (e.g., the cathode layer 255). Lithium-ion batteries can include a graphite chemistry, a silicon-graphite chemistry, or a lithium metal chemistry for the anode layer (e.g., the anode layer 245).

For example, lithium-ion batteries can include an olivine phosphate (LiMPO₄, M=Fe and/or Co and/or Mn and/or Ni)) chemistry, LISICON or NASICON Phosphates (Li₃M₂(PO₄)₃ and LiMPO₄Oₓ, M=Ti, V, Mn, Cr, and Zr), for example lithium iron phosphate (LFP), lithium iron manganese phosphate (LMFP), layered oxides (LiMO₂, M=Ni and/or Co and/or Mn and/or Fe and/or Al and/or Mg) examples, NMC (Nickel Manganese Cobalt) chemistry, an NCA (Nickel Cobalt Aluminum) chemistry, or an LCO (lithium cobalt oxide) chemistry for a cathode layer, lithium rich layer oxides (Li₁₊ₓM₁₋ₓO₂) (Ni, and/or Mn, and/or Co), (OLO or LMR), spinel (LiMn₂O₄) and high voltage spinels (LiMn_{1.5}Ni_{0.5}O₄), disordered rock salt, Fluorophosphates Li₂FePO₄F (M=Fe, Co, Ni) and Fluorosulfates LiMSO₄F (M=Co, Ni, Mn) (e.g., the cathode layer 255). Lithium-ion batteries can include a graphite chemistry, a silicon-graphite chemistry, or a lithium metal chemistry for the anode layer (e.g., the anode layer 245). For example, a cathode layer having an LFP chemistry can have a redox potential of 3.4 V vs. Li/Li⁺, while an anode layer having a graphite chemistry can have a 0.2 V vs. Li/Li⁺ redox potential.

Electrode layers can include anode active material or cathode active material, commonly in addition to a conductive carbon material, a binder, or other additives as a coating on a current collector (metal foil). The chemical composition of the electrode layers can affect the redox potential of the electrode layers. For example, cathode layers (e.g., the cathode layer 255) can include medium to high-nickel content (50 to 80%, or equal to 80% Ni) lithium transition metal oxide, such as a particulate lithium nickel manganese cobalt oxide (“LiNMC”), a lithium nickel cobalt aluminum oxide (“LiNCA”), a lithium nickel manganese cobalt aluminum oxide (“LiNMCA”), or lithium metal phosphates like lithium iron phosphate (“LFP”) and lithium iron manganese phosphate (“LMFP”). Anode layers (e.g., the anode layer 245) can include conductive carbon materials such as graphite, carbon black, carbon nanotubes, and the like. Anode layers can include Super P carbon black material, Ketjen Black, Acetylene Black, SWCNT, MWCNT, graphite, carbon nanofiber, or graphene, for example.

Electrode layers can also include chemical binding materials (e.g., binders). Binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Binder materials can include agar-agar, alginate, amylose, Arabic gum, carrageenan, cascine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene)polystyrene sulfonate (PEDOT-PSS), polyacrylic acid (PAA), poly (methyl acrylate) (PMA), poly(vinyl alcohol) (PVA), poly(vinyl acetate) (PVAc), polyacrylonitrile (PAN), polyisoprene (PIpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

Current collector materials (e.g., a current collector foil to which an electrode active material is laminated to form a cathode layer or an anode layer) can include a metal material. For example, current collector materials can include aluminum, copper, nickel, titanium, stainless steel, or carbonaceous materials. The current collector material can be formed as a metal foil. For example, the current collector material can be an aluminum (Al) or copper (Cu) foil. The current collector material can be a metal alloy, made of Al, Cu, Ni, Fe, Ti, or combination thereof. The current collector material can be a metal foil coated with a carbon material, such as carbon-coated aluminum foil, carbon-coated copper foil, or other carbon-coated foil material.

The layer 260 can include or be made of a liquid electrolyte material. For example, the layer 260 can be or include at least one layer of polymeric material (e.g., polypropylene, polyethylene, or other material) including pores that are wetted (e.g., saturated with, soaked with, receive, are filled with) a liquid electrolyte substance to enable ions to move between electrodes. The liquid electrolyte material can include a lithium salt dissolved in a solvent. The lithium salt for the liquid electrolyte material for the layer 260 can include, for example, lithium tetrafluoroborate (LiBF₄), lithium hexafluorophosphate (LiPF₆), and lithium perchlorate (LiCIO₄), among others. The solvent can include, for example, dimethyl carbonate (DMC), ethylene carbonate (EC), and diethyl carbonate (DEC), among others. Liquid electrolyte is not necessarily disposed near the layer 260, but the liquid electrolyte can fill the battery cells 120 in many different ways. The layer 260 can include or be made of a solid electrolyte material, such as a ceramic electrolyte material, polymer electrolyte material, or a glassy electrolyte material, or among others, or any combination thereof.

In some embodiments, the solid electrolyte film can include at least one layer of a solid electrolyte. Solid electrolyte materials of the solid electrolyte layer can include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr. La, and B=Al, Ti), garnet-type with formula A₃B₂(XO₄)₃ (A=Ca, Sr, Ba and X=Nb, Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂S₁₂) and/or sulfide-based lithium argyrodites with formula Li₆PS₅X (X=Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

In examples where the layer 260 includes a liquid electrolyte material, the layer 260 can include a non-aqueous polar solvent. The non-aqueous polar solvent can include a carbonate such as ethylene carbonate, propylene carbonate, diethyl carbonate, ethyl methyl carbonate, dimethyl carbonate, or a mixture of any two or more thereof. The layer 260 can include at least one additive. The additives can be or include vinylidene carbonate, fluoroethylene carbonate, ethyl propionate, methyl propionate, methyl acetate, ethyl acetate, or a mixture of any two or more thereof. The layer 260 can include a lithium salt material. For example, the lithium salt can be lithium perchlorate, lithium hexafluorophosphate, lithium bis(fluorosulfonyl)imide, lithium bis(trifluorosulfonyl)imide, or a mixture of any two or more thereof. The lithium salt may be present in the layer 260 from greater than 0 M to about 1.5 M. Once disposed to the battery cell 120, liquid electrolyte can be present and touching battery subcomponents present within the battery cell 120. The battery subcomponents can include the cathode, the anode, the separator, the current collector, etc.

FIG. 2F depicts an example flowchart of a process of forming a battery subassembly 115. At step 270, at least one battery cell 120 is loaded into a cell carrier (described herein). At step 272, an adhesive (e.g., wicking adhesive) is applied to the battery cells 120 or carrier to facilitate fixing the battery cells 120 to the carrier. At step 274, a current collector assembly (CCA) is coupled with the battery cells 120. At step 276, the CCA is welded to at least one cell terminal (e.g., button). At step 278, a first cell carrier, a thermal component 215, and a second cell carrier are coupled together to form a subassembly. At step 280, terminal busbars and series busbars are coupled with the subassembly. At step 282, various components such as fuses, switches, current sensors, temperature sensors, voltage sensors, thermistors, contactors, and/or the like can be coupled with the subassembly. For example, a thermistor harness and/or a battery voltage temperature monitor (BVT) configured to receive electrical signals, data packets, measurements, sensor readings, or other data to indicate characteristics of the battery subassembly such as temperature, voltage, state of charge and/or fault status for communication to a battery management system (BMS) can be coupled to the subassembly. At step 284, potting occurs (e.g., partially or completely filling a space between the batteries with a compound to provide resistance to shock waves or vibrations) subsequent the first carrier is coupled with the second carrier with the thermal component 215 disposed in between the carriers. At step 286, a touch cover can be coupled with the subassembly. The process of forming the subassembly, as shown and described herein in which the thermal component 215 is the central unit and can act as a central datumning component thereby eliminating shear walls and external datums and/or facilitate a more stable and efficient manufacturing process.

As depicted in FIG. 2G, among others, the battery subassembly 115 can include a plurality of battery cells 120 and at least one current collector 290. The current collector 290 can include an electrically conductive member that can electrically couple multiple battery cells 120 with each other. For example, the current collector 290 can electrically couple multiple battery cells 120 together in a series configuration, a parallel configuration, or some other configuration, such as by physically contacting one or more terminals of the multiple battery cells 120. The battery pack 110 can include one current collector 290 for each battery subassembly 115. For example, as depicted in FIG. 2G, among others, each subassembly 115 can include multiple battery cells 120 and one current collector 290 to electrically couple the battery cells 120 together.

The battery cells 120 can be positioned adjacent to one another such that at least a portion of battery cells 120 are in contact (e.g., touching, abutting) with at least one adjacent battery cell 120. The battery cells 120 can be positioned such that at least a portion of a battery cell 120 are not in contact with an adjacent battery cell 120. For example, as depicted in FIGS. 2G, due to the arrangement, configuration, and shapes of the battery cells, the battery cells 120 can be positioned relative to at least one adjacent battery cell 120 with an interstitial area 295 positioned between the adjacent battery cells 120. The interstitial area 295 can include a space, gap, opening, or cavity positioned between adjacent battery cells 120. The battery cells 120 can be completely or partially enveloped by the interstitial area 295 in a radial direction. For example, if a battery cell 120 is not contacting any adjacent battery cell 120, the interstitial area 295 can surround a radial surface of the battery cell 120 in a radial direction (e.g., excluding a top and bottom, which can be coupled with the current collector 290 or a thermal component 215, for example). In the examples in which a portion of the battery cell 120 contacts at least one adjacent battery cell 120, the interstitial area 295 can partially surround the battery cell 120. For example, multiple discrete (e.g., separated, individual) interstitial areas 295 can exist within the subassembly 115, with each interstitial area 295 separated from other interstitial areas 295 because of at least two battery cells abutting (e.g., contacting, touching) each other. The interstitial area 295 can exist as a product of a shape, arrangement, and configuration of the battery cells 120. For example, the battery cells 120 can be cylindrical in form such that a group of multiple (e.g., three, four, or some other number) of neighboring battery cells 120 can only contact each other along a line or an edge, rather than a surface (as may be the case with prismatic battery cells 120, for example). At least a portion of the interstitial area 295 (e.g., 80-100%) can be filled with potting and at least a portion of an area between a battery cell 120 and the thermal component 215 can be filled with a thermal adhesive. As depicted in the arrows in FIG. 2G, this configuration of the battery pack 110 allows for a load path to extend across an approximate midpoint of the battery cells 120 along a wall of the carriers described herein, and through flanges of the carriers described herein.

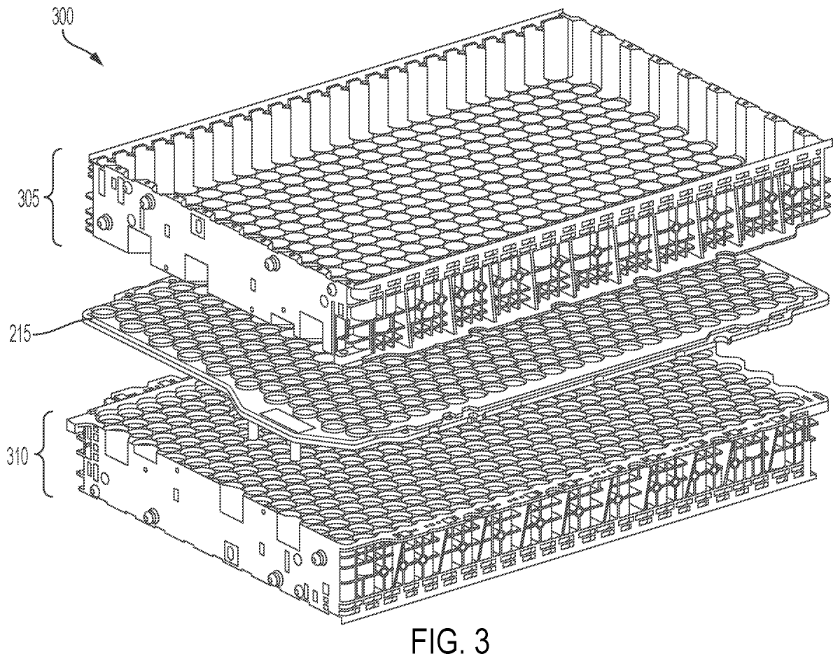

FIG. 3 depicts an example perspective exploded view of a battery system 300. The battery system 300 can include a first cell carrier 305, a second cell carrier 310, and a thermal component 215. The first cell carrier 305 can include one or more components to hold or carry at least one battery cell 120 in position. For example, the first cell carrier 305 can include one or more pockets (e.g., battery cell-shaped holes, clamps, or other components that can receive a battery cell 120 to couple the battery cell 120 with the first carrier 305). The second cell carrier 310 can include a similar configuration and size as the first cell carrier 305. For example, the second cell carrier 310 can include at least one pocket to receive at least one battery cell 120. The thermal component 215 can be positioned at a middle portion of the battery system 300 between the first cell carrier 305 and the second cell carrier 310.

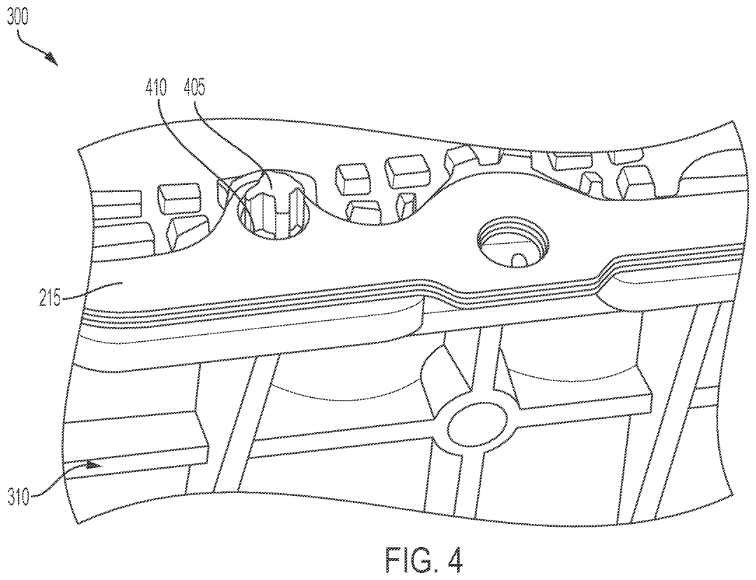

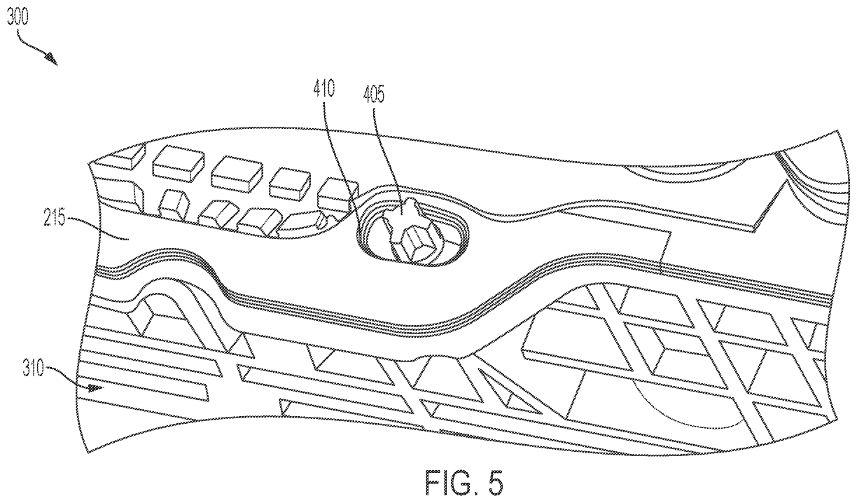

FIGS. 4 and 5 depict example detailed views of a portion of the battery system 300. For example, FIGS. 4 and 5 depict a portion of the second battery cell carrier 310 coupled with a portion of the thermal component 215. For example, at least one of the first cell carrier 305 or the second cell carrier 310 can include a locating feature 405. The locating feature 405 can be or can include a post (e.g., protrusion, boss, or similar feature that extends from a surface of the cell carrier). For example, as depicted in at least FIGS. 4 and 5, the locating feature 405 can include a post that extends from the second cell carrier 310 in a direction towards the thermal component 215 and the first cell carrier 305. The thermal component 215 can include at least one respective datum 410. For example, the datum 410 can be or can include an opening (e.g., hole, slot, aperture) that can at least partially receive a portion of the locating feature 405.

The battery system 300 can include a plurality of locating features 405 and a plurality of corresponding datums 410 on the thermal component 215 that can each align with one another. For example, the second cell carrier 310 can include four locating features 405 (e.g., two locating features 405 each positioned on opposing sides of the cell carrier). Two of the locating features 405 can extend through at least a portion of a first type of datum 410 of the thermal component 215 and two of the locating features 405 can extend through at least a portion of a second type of datum 410 of the thermal component 215. For example, the first type of datum 410 can be or can include a 2-way datum (e.g., such as a hole as depicted in FIG. 4). The 2-way datum can restrict the first cell carrier 305 or the second cell carrier 310 relative to the thermal component 215 along one axis (e.g., in two degrees of freedom of movement). The second type of datum 410 can be or can include a 4-way datum (e.g., such as a slot as depicted in FIG. 5). The 4-way datum can restrict the first cell carrier 305 or the second cell carrier 310 relative to the thermal component 215 along two axes (e.g., in four degrees of freedom of movement). For example, the thermal component 215 can include two 2-way datums 410 and two 4-way datums 410 positioned on opposing sides of the thermal component 215. The system 300 can include more or less locating features 405 or more or less datums 410. For example, the system 300 can include one locating feature 405 or datum 410, two locating features 405 or datums 410, three locating features 405 or datums 410, or more than four locating features 405 or datums 410.

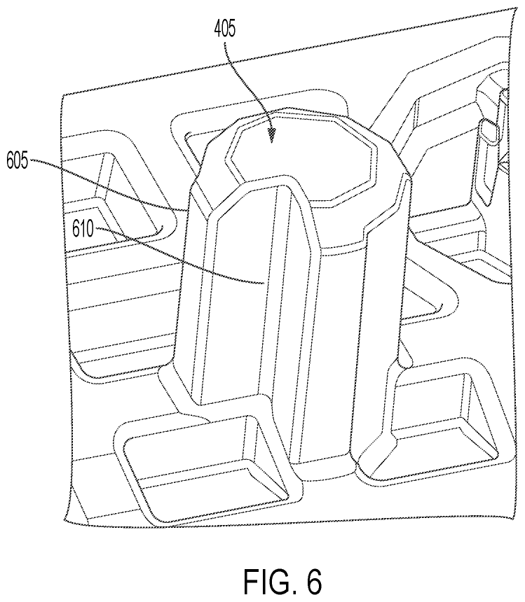

The one or more locating features 405 can include a variety of shapes or sizes. For example, FIGS. 6 depicts a perspective view of an example locating feature 405. The locating feature 405 can include a body 605 having at least one cutout 610. For example, the body 605 can define a substantially rounded or cylindrical shape and the cutout 610 can include a portion of the body 605 that is at least partially discontinuous or cut away from one portion of the body 605 towards a center portion of the body 605. The body 605 can include a plurality of cutouts 610. For example, as depicted in at least FIGS. 4 and 5, the locating feature 405 can include a plurality (e.g., four) cutouts each located in a circumferential direction of the locating feature 405 to define a cross-shaped cross section. The locating feature 405 can include other types of shapes of cutouts 610. For example, the body 605 can include a rectangular shape, a pentagonal shape, an octagonal shape, a square shape, an asymmetrical shape, or another shape. The body 605 can include more or less cutouts 610. For example, the body 605 can include one cutout 610, two cutouts 610, three cutouts 610, more than four cutouts 610, or the body 605 may not have any cutouts 610. As described herein, the cutouts 610 can at least partially receive an adhesive to improve adhesive flow path control.

At least a portion of the body 605 of the locating feature 405 can taper in at least one direction (e.g., from the surface of the cell carrier in a direction away from the cell carrier, at a topmost section of the locating feature). For example, at least a portion of the outer diameter of the body 605 can be decreasing in a direction moving away from the cell carrier.

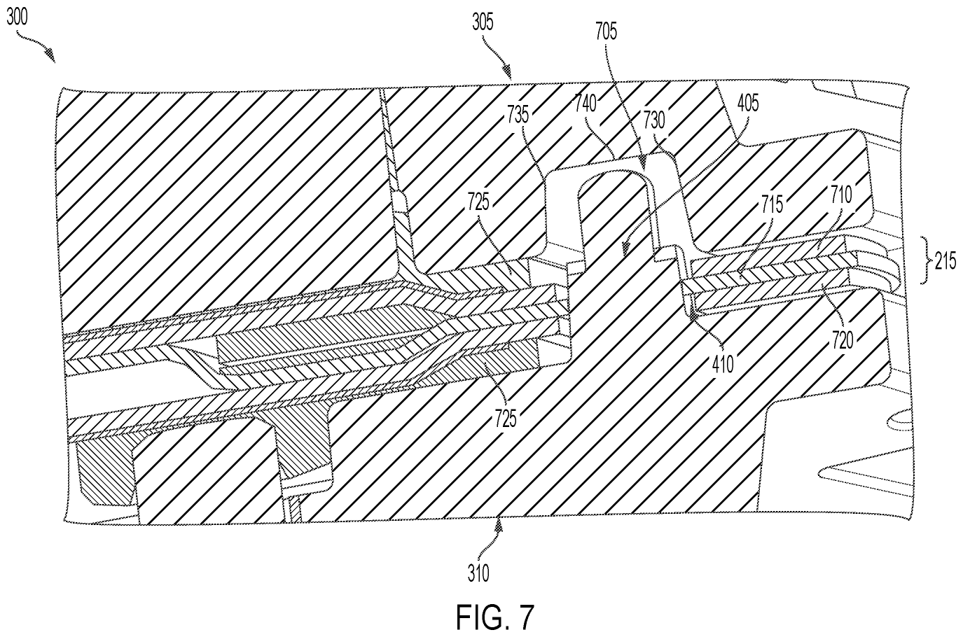

FIG. 7 depicts an example side sectional view of a portion of the battery system 300. For example, FIG. 7 depicts a portion of the second cell carrier 310 having at least one locating feature 405, a portion of the first cell carrier 305, and a portion of the thermal component 215 disposed between and at least partially in contact with the first cell carrier 305 and the second cell carrier 310. As depicted in at least FIG. 7, the first cell carrier 305, or the second cell carrier 310, can include at least one respective datum 705. The datum 705 can be or can include an opening that can at least partially receive a locating feature 405 of the second cell carrier 310. For example, as depicted in at least FIG. 7, the datum 705 of the first cell carrier 305 can at least partially align with a respective datum 410 of the thermal component 215 and at least partially receive the locating feature 405. In other words, the locating feature 405 can extend through both the datum 410 of the thermal component 215 and the datum 705 of the first cell carrier 305 to facilitate aligning each of the first cell carrier 305, the second cell carrier 310, and the thermal component 215 with each other. The first cell carrier 305 can include a plurality of datums 705. At least one of the datums 705 can include a first type of datum (e.g., a 2-way datum) and at least one of the datums 705 can include a second type of datum (e.g., 4-way datum). For example, the first cell carrier 305 can include two 2-way datums 705 and two 4-way datums 705 positioned on opposing sides of the first cell carrier 305. The system 300 can include more or less datums 705. For example, the system 300 can include one datum 705, two datums 705, three datums 705, or more than four datums 705.

Each of the first cell carrier 305 and the second cell carrier 310 can include one or more locating features 405 and one or more datums 705. For example, one side (e.g., one flange extending beyond a sidewall) of the first cell carrier 305 can include a 2-way datum 705, a first locating feature 405, a 4-way datum 705, and a second locating feature 405. The opposing second cell carrier 310 can include a corresponding first locating feature 405 to insert into the 2-way datum 705 of the first cell carrier 305, a 2-way datum 705 that receives the first locating feature 405 of the first cell carrier 305, a second locating feature 405 to insert into the 4-way datum 705 of the first cell carrier 305, and a 4-way datum 705 that receives the second locating feature 405 of the first cell carrier 305. The thermal component 215 can include at least one datum 410 that is the same type of datum as the datum 705 of the first cell carrier 305 or the second cell carrier 310 (e.g., a 2-way datum 410 to align and match with a corresponding 2-way datum 705 of the first cell carrier 305 or the second cell carrier 310 or a 4-way datum 410 to align and match with a corresponding 2-way datum 705 of the first cell carrier 305 or the second cell carrier 310).

Each of the first cell carrier 305, the second cell carrier 310, and the thermal component 215 can include a plurality of datums 410, 705 and locating features 405 to align the first cell carrier 305, the second cell carrier 310, and the thermal component 215 in multiple directions. For example, the second cell carrier 310 can include a locating feature 405 located at approximately each corner of the second cell carrier 310 and each of the first cell carrier 305 and the thermal component 215 can include corresponding datums 410, 705. The datums 410, 705 and locating features 405 can be formed as part of the respective cell carriers 305, 310 and thermal component 215 to eliminate or reduce the need for datums or other positioning features positioned external to the system 300 (e.g., not monolithically formed with at least one of the first cell carrier 305, the second cell carrier 310, or the thermal component 215.

The thermal component 215 can include one or more portions making up the thermal component 215. For example, the thermal component 215 can include a first thermal component portion 710, a second thermal component portion 715, and a third thermal component portion 720. As depicted in at least FIG. 7, the first thermal component portion 710, the second thermal component portion 715, and the third thermal component portion 720 can at least partially define a datum 410 of the thermal component 215. For example, the first thermal component portion 710, the second thermal component portion 715, and the third thermal component portion 720 can be stacked together to form the thermal component 215 and the datum 410 (e.g., opening) can extend through each of the first thermal component portion 710, the second thermal component portion 715, and the third thermal component portion 720. In other words, the thermal component 215 can include a plurality of at least partially stacked sections defining the datum 410.

The first thermal component portion 710 and the third thermal component portion 720 can branch out in opposing directions in at least one direction. For example, the second thermal component portion 715 can extend in a serpentine (e.g., “S”-shaped) manner such that, at a first section of the thermal component 215, at least a portion of the second thermal component portion 715 is in direct contact with the first thermal component portion 710 but is not in direct contact with the third thermal component portion 720 (e.g., such that a space is defined between the second thermal component portion 715 and the third thermal component portion 720) and, at a second section of the thermal component 215, at least a portion of the second thermal component portion 715 is in direct contact with the third thermal component portion 720 but is not in direct contact with the first thermal component portion 710 (e.g., such that a space is defined between the second thermal component portion 715 and the first thermal component portion 710). The datum 410 of the thermal component 215 can vary in diameter. For example, a diameter of the datum 410 in at least one of the plurality of sections (e.g., the first thermal component portion 710, the second thermal component portion 715, or the third thermal component portion 720) can vary in diameter relative to one of the remaining sections. For example, the diameter of the second thermal component portion 715 can be lesser than the first thermal component portion 710 or the third thermal component portion 720 at the datum 410.

At least a portion of the system 300 can include an added adhesive 725 to facilitate fixing the first cell carrier 305, the second cell carrier 310, and the thermal component 215 relative to one another after they are aligned (e.g., after the datums 410, 705 receive at least a portion of a corresponding locating feature 405). For example, the system 300 can include adhesive 725 applied in between the first cell carrier 305 and the second cell carrier 310. The adhesive 725 can flow throughout a portion of the system 300. For example, at least one portion of the locating feature 405 (e.g., one or more cutouts 610) can receive the adhesive 725. In other words, the cutouts 610 of the locating feature 405 or the tapering at a topmost portion of the locating feature 405 allow for a flow path for the adhesive 725. This flow path can facilitate increasing a control of the adhesive (e.g., such that the adhesive flows in a controlled manner within the flow path).

At least a portion of the datum 705 of the first cell carrier 305 can taper to facilitate creating a flow path for adhesive 725 to flow. For example, the datum 705 can be defined by a first wall 730, a second opposing wall 735, and a third wall 740 extending between the first wall 730 and the second wall 735. The first wall 730 or the second wall 735 can taper in a direction extending from the opening of the datum 705 towards the third wall 740 to facilitate a flow of adhesive 725 into a portion of the datum 705 (e.g., such that the adhesive 725 can at least partially contact the locating feature 405). For example, a diameter at the start of the opening of the datum 705 can be greater than a diameter or length of the third wall 740.

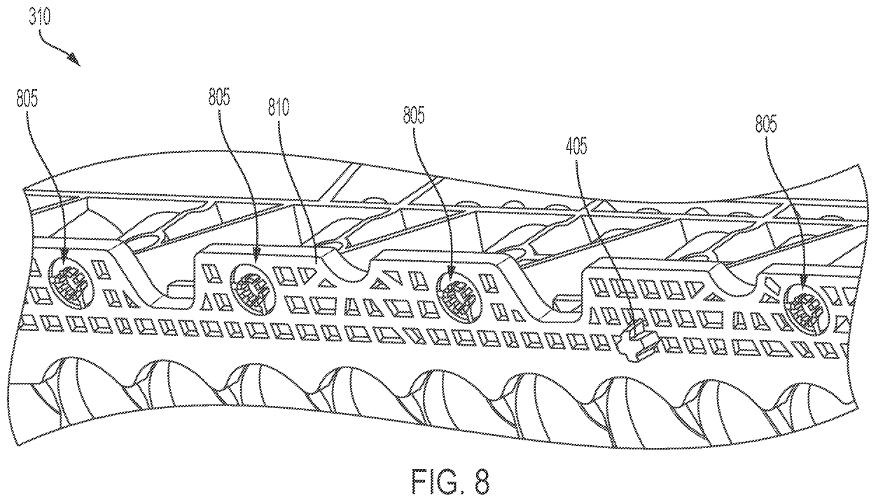

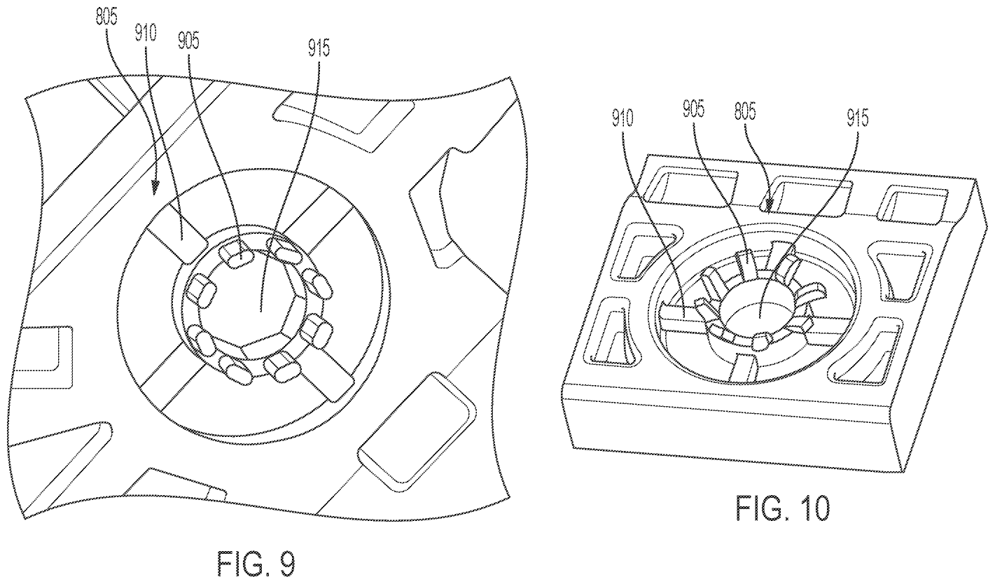

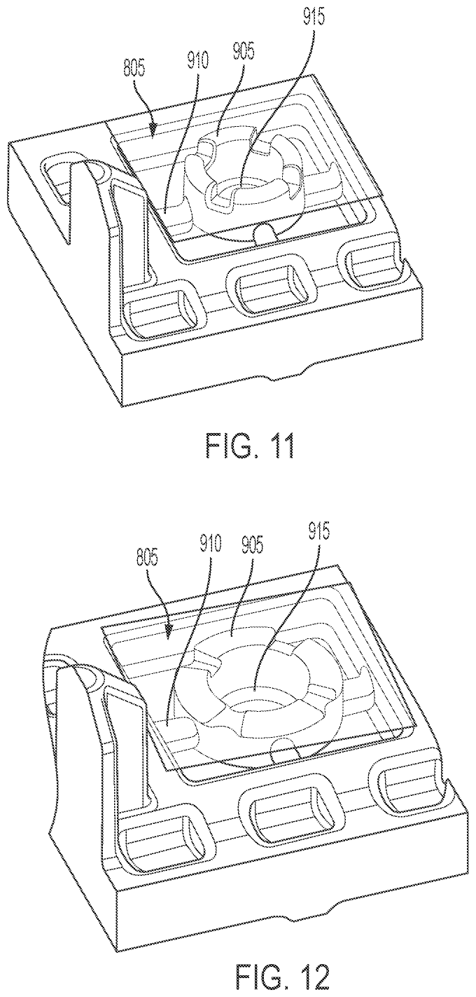

FIG. 8 depicts an example perspective view of a portion of the second cell carrier 310 (or the first cell carrier 305) having at least one deformable protrusion 805 (e.g., a deformable protruding rib that protrudes from the cell carrier). The deformable protrusions 805 can at least partially protrude beyond a surface 810 of the second cell carrier 310. For example, FIGS. 9 and 11 depict detailed views of the deformable protrusion 805. The deformable protrusion 805 can include, for example, one or more teeth 905 that extend from a surface 810 of the respective carrier (e.g., the second cell carrier 310) in a direction towards the thermal component 215 and the opposing other carrier (e.g., the first cell carrier 305). For example, the teeth 905 can extend circumferentially around a center 915 of the deformable protrusion 805. The deformable protrusion 805 can include at least one spoke 910 that extends outward along the cell carrier from the teeth 905 to add strength to the teeth 905. At least one of the teeth 905 can deform responsive to contacting or engaging with one or more of the thermal component 215 or the other cell carrier (e.g., first cell carrier 305). For example, the teeth 905 can deform to facilitate absorbing a load applied by the first or second cell carriers 305, 310 to the thermal component 215 when these components are coupled together. For example, FIGS. 10 and 12 depict the deformable protrusion 805 in a deformed state when the teeth 905 contact a portion of the thermal component 215 (or a portion of the first cell carrier 305). As depicted in at least FIGS. 8-12, the deformable protrusion 805 can include any amount of teeth 905 (e.g., four teeth 905, eight teeth 905, or more or less teeth 905) of one or more sizes.

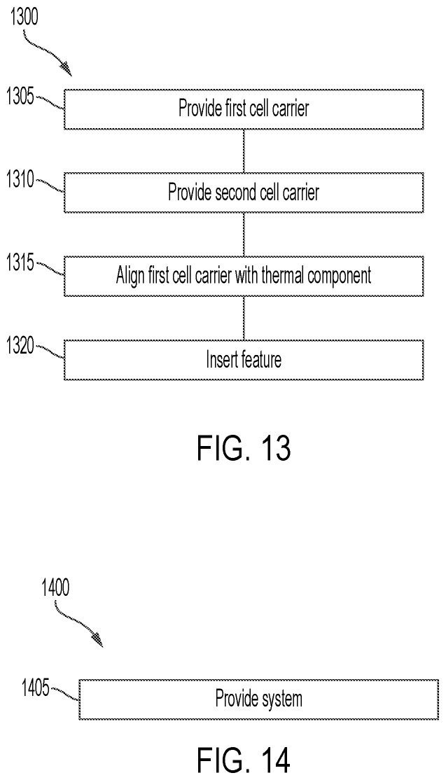

FIG. 13 depicts an example method 1300. The method 1300 can include providing a first cell carrier 305 and a second cell carrier 310, as depicted in acts 1305 and 1310. Each of the first cell carrier 305 and the second cell carrier 310 can hold one or more battery cells 120. The second cell carrier 310 can include at least one locating feature 405. For example, the locating feature 405 can be or can include a post (e.g., a protrusion, a boss, an extension, a cylindrical rod, etc.). The first cell carrier 305 can include a datum 705 (e.g., opening, aperture, etc.) that can at least partially receive the locating feature 405. A thermal component 215 can be disposed between the first cell carrier 305 and the second cell carrier 310 and can include a datum 410 that can at least partially receive the locating feature 405.

The method 1300 can include aligning the datum 410 of the thermal component 215 and the datum 705 of the first cell carrier 305, as depicted in act 1315. For example, the datums 410, 705 can align such that they substantially overlap each other (e.g., such that the locating feature 405 could protrude through each of the datums 705, 410 in series), as depicted in at least FIG. 7.

The method 1300 can include inserting the locating feature 405 of the second cell carrier 310 with the datum 410 of the thermal component 215 and with the datum 705 of the first cell carrier 305, as depicted in act 1320. For example, the locating feature 405 can protrude through the datum 410 of the thermal component 215 and the datum 705 of the first cell carrier 305 to align and facilitate coupling the first cell carrier 305, the second cell carrier 310, and the thermal component with one another.

FIG. 14 depicts an example method 1400. The method 1400 can include providing the battery system 300, as depicted in act 1405. The battery system 300 can include a first cell carrier 305, a second cell carrier 310, or a thermal component 215. The first cell carrier 305 can include one or more components to hold or carry at least one battery cell 120 in position. The second cell carrier 310 can include a similar configuration and size as the first cell carrier 305. The thermal component 215 can be positioned at a middle portion of the battery system 300 between the first cell carrier 305 and the second cell carrier 310.

The battery system 300 can include a plurality of locating features 405 and a plurality of corresponding datums 410 on the thermal component 215. For example, the second cell carrier 310 can include four locating features 405. Two of the locating features 405 can extend through at least a portion of a first type of datum 410 of the thermal component 215 and two of the locating features 405 can extend through at least a portion of a second type of datum 410 of the thermal component 215. For example, the first type of datum 410 can be or can include a 2-way datum. The second type of datum 410 can be or can include a 4-way datum.

The first cell carrier 305, or the second cell carrier 310, can include at least one respective datum 705. The datum 705 can be or can include an opening that can at least partially receive a locating feature 405 of the second cell carrier 310. For example, the datum 705 of the first cell carrier 305 can at least partially align with a respective datum 410 of the thermal component 215 and at least partially receive the locating feature 405. In other words, the locating feature 405 can extend through both the datum 410 of the thermal component 215 and the datum of the first cell carrier 305 to facilitate aligning each of the first cell carrier 305, the second cell carrier 310, and the thermal component 215 with each other. The first cell carrier 305 can include a plurality of datums 705. At least one of the datums 705 can include a first type of datum (e.g., a 2-way datum) and at least one of the datums 705 can include a second type of datum (e.g., 4-way datum).

To align and couple the battery system 300 together, a datum 705 of the first cell carrier 305 can align with a datum 410 of the thermal component 215. A locating feature 405 of the second cell carrier 310 can at least partially protrude through the aligned datums 705, 410 to align the first cell carrier 305 with the thermal component 215 and with the second cell carrier 310.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, the first cell carrier or second cell carrier can include any amount of datums or locating features positioned at different locations of the carriers. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A battery system, comprising:
a first cell carrier comprising a first datum;
the first datum of the first cell carrier configured to:
align with a second datum of a thermal component; and
at least partially receive a locating feature of a second cell carrier.

2. The battery system of claim 1, comprising:
the locating feature comprising a post having at least one cutout; and
at least a portion of the at least one cutout configured to receive an adhesive.

3. The battery system of claim 1, comprising:
the locating feature comprising at least one tapered portion to provide an adhesive flow path.

4. The battery system of claim 1, comprising:
the second cell carrier comprising a rib that protrudes beyond a surface of the second cell carrier; and
the rib configured to deform responsive to the second cell carrier coupling with the first cell carrier.

5. The battery system of claim 1, comprising:
the thermal component comprising a plurality of at least partially stacked sections defining the second datum; and
a diameter of the second datum in at least one of the plurality of sections varying from the diameter of the second datum in a remaining one of the plurality of sections.

6. The battery system of claim 1, comprising:
the first datum comprising a 2-way datum to restrict the first cell carrier to two degrees of freedom of movement.

7. The battery system of claim 1, comprising:
the second datum comprising a 4-way datum to restrict the first cell carrier to four degrees of freedom of movement.

8. The battery system of claim 1, comprising:
the first datum and the second datum comprising a same type of datum.

9. An electric vehicle, comprising:
a battery system, comprising:
a first cell carrier comprising a first datum;
the first datum of the first cell carrier configured to:
align with a second datum of a thermal component; and
at least partially receive a locating feature of a second cell carrier.

10. The electric vehicle of claim 9, comprising:
the locating feature comprising a post having at least one cutout; and
at least a portion of the at least one cutout configured to receive an adhesive.

11. The electric vehicle of claim 9, comprising:
the locating feature comprising at least one tapered portion to provide an adhesive flow path.

12. The electric vehicle of claim 9, comprising:
the second cell carrier comprising a rib that protrudes beyond a surface of the second cell carrier; and
the rib configured to deform responsive to the second cell carrier coupling with the first cell carrier.

13. The electric vehicle of claim 9, comprising:
the thermal component comprising a plurality of at least partially stacked sections defining the second datum; and
a diameter of the second datum in at least one of the plurality of sections varying from the diameter of the second datum in a remaining one of the plurality of sections.

14. The electric vehicle of claim 9, comprising:
the first datum comprising a 2-way datum to restrict the first cell carrier to two degrees of freedom of movement.

15. The electric vehicle of claim 9, comprising:
the second datum comprising a 4-way datum to restrict the first cell carrier to four degrees of freedom of movement.

16. The electric vehicle of claim 9, comprising:
the first datum and the second datum comprising a same type of datum.

17. A method, comprising:
providing a first cell carrier comprising a first datum and a second cell carrier comprising a locating feature;
aligning the first datum of the first cell carrier with a second datum of a thermal component; and
at least partially inserting the locating feature of the second cell carrier through the first datum and the second datum to couple the first cell carrier, the second cell carrier, and the thermal component.

18. The method of claim 17, comprising:
the locating feature comprising a post having at least one cutout; and
at least a portion of the at least one cutout configured to receive an adhesive.

19. The method of claim 17, comprising:
the locating feature comprising at least one tapered portion to provide an adhesive flow path.

20. The method of claim 17, comprising:
the second cell carrier comprising a rib that protrudes beyond a surface of the second cell carrier; and
the rib configured to deform responsive to the second cell carrier coupling with the first cell carrier.
